(19) United States
(12) Patent Application Publication
(10) Pub. No.: US 2013/0147543 A1
(43) Pub. Date: Jun. 13, 2013

(54) Apparatus and Method for Fractional Charge Pumps

(71) Applicants: Heping Dai, Plano, TX (US); Hengchun Mao, Plano, TX (US)

(72) Inventors: Heping Dai, Plano, TX (US); Hengchun Mao, Plano, TX (US)

(73) Assignee: FutureWei Technologies, Inc., Plano, TX (US)

(21) Appl. No.: 13/323,639

(22) Filed: Dec. 12, 2011

(51) Int. Cl. G05F 3/08

(52) U.S. Cl. 327/536

(57) ABSTRACT

An embodiment apparatus comprises a plurality of flying capacitors coupled between a dc input power source and an output capacitor and switching circuitry coupled to the plurality of flying capacitors. The switching circuitry is configured such that in a first operational phase, the dc input power source and the plurality of flying capacitors in a first capacitor configuration are stacked together and further coupled to the output capacitor and in a second operational phase, the plurality of flying capacitors in a second capacitor configuration are coupled between ground and the output capacitor.

### TECHNICAL FIELD

The present invention relates to an apparatus and method for fractional charge pumps, and, in particular embodiments, to a ⅖ charge pump and a ⅗ charge pump.

### BACKGROUND

An electronic circuit such as a power management integrated circuit today often requires input power in a specific range. However, an input power source such as a rechargeable battery or a dc power supply may provide a supply voltage out of the specific range. When the voltage of the input power source is lower than the specific range, a step-up dc/dc converter may be employed to convert the voltage of the input power source into a regulated voltage within the specific range. On the other hand, when the voltage of the input power source is higher than the specific range, a step-down dc/dc converter may be used to convert the voltage of the input power source into a lower voltage to satisfy the operational voltage to which the power management integrated circuit is specified.

There may be a variety of dc/dc conversion topologies. In accordance with the topology difference, dc/dc converters can be divided into three categories, namely, switching dc/dc converters, linear regulators and charge pumps. A simple charge pump may comprise a flying capacitor and its corresponding switching circuitry. During a first phase of a switching cycle, the switching circuitry of the charge pump is configured such that the flying capacitor is charged from an input power source. During a second phase of the switching cycle, the switch circuitry of the charge pump is reconfigured such that the energy storing in the flying capacitor is transferred to the output of the charge pump.

As integrated circuits such as power management integrated circuits become increasingly advanced while shrinking in size at the same time, a compact and high efficiency dc/dc conversion topology is desirable. In comparison with other topologies, charge pumps are less complicated because charge pumps are formed by a plurality of charging capacitors and their corresponding switches. In addition, charge pumps have a small footprint and are capable of generating a high efficient power conversion by switching flying capacitors between different charging and discharging phases. As a result, charge pumps can provide compact and efficient power for integrated circuits. In particularly, charge pump converters may provide a bias voltage (e.g., 5V) for an integrated circuit operating under a 12V input power source.

In order to further improve the efficiency of a charge pump powered integrated circuit, fractional charge pumps may be employed to generate an output voltage equal to the input voltage multiplied by a non-integer multiplication factor. For example, a 1.5 charge pump can boost the output voltage to as much as 1.5 times the input voltage. There may be two flying capacitors in a 1.5 charge pump. The 1.5 charge pump operates by switching the two flying capacitors between two phases. During the first phase, the two flying capacitors are connected in series and charged from the input voltage source. According to the capacitor divider theorem, the voltage across each flying capacitor is about one half of the input voltage. During the second phase, after a reconfiguration of the flying capacitors, the two flying capacitors are connected in parallel and stacked on top of the input voltage source. As a result, the total voltage to the load is about 1.5 times the input voltage.

### SUMMARY OF THE INVENTION

These and other problems are generally solved or circumvented, and technical advantages are generally achieved, by preferred embodiments of the present invention which provide an apparatus and method for a fractional charge pump.

In accordance with an embodiment, an apparatus comprises a plurality of flying capacitors and a switching circuit coupled to the plurality of flying capacitors, wherein the switching circuit is configured such that in a first operational phase, a dc input power source and the plurality of flying capacitors in a first capacitor configuration are stacked together and further coupled to an output capacitor and in a second operational phase, the plurality of flying capacitors in a second capacitor configuration are coupled between ground and the output capacitor.

In accordance with another embodiment, a charge pump comprises a first capacitor group comprising a first flying capacitor, a second capacitor group comprising a second flying capacitor and a third flying capacitor, wherein the first capacitor group and the second capacitor group are between a dc input power source and an output capacitor and a switching circuit coupled to the first capacitor group and the second capacitor group, wherein the switching circuit is configured such that in a first operational phase, the dc input power source charges the output capacitor through the first capacitor group and the second capacitor group and in a second operational phase, the first capacitor group and the second capacitor group charges the output capacitor.

In accordance with yet another embodiment, a method comprises configuring a switching circuit to form a first capacitor configuration, a dc power source charging an output capacitor through the first capacitor configuration, reconfiguring the switching circuit to form a second capacitor configuration and transferring energy stored in the second capacitor configuration to the output capacitor.

An advantage of an embodiment of the present invention is achieving a fractional charge pump with three flying capacitors and two operational phases.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a block diagram of a fractional charge pump in accordance with an embodiment;

FIG. 2 illustrates schematic diagrams of the charging capacitor configuration and the discharging capacitor configuration in accordance an embodiment;

FIG. 3 illustrates schematic diagrams of the charging capacitor configuration and the discharging capacitor configuration in accordance another embodiment;

FIG. 4 illustrates in detail a schematic diagram of a ⅖ charge pump in accordance with an embodiment;

FIG. 5 illustrates in detail a schematic diagram of a ⅖ charge pump operating in a charging phase in accordance with an embodiment;

FIG. 6 illustrates in detail a schematic diagram of a ⅖ charge pump operating in a discharging phase in accordance with an embodiment;

FIG. 7 illustrates in detail a schematic diagram of a ⅗ charge pump in accordance with an embodiment;

FIG. 8 illustrates in detail a schematic diagram of a ⅗ charge pump operating in a charging phase in accordance with an embodiment; and

FIG. 9 illustrates in detail a schematic diagram of a ⅗ charge pump operating in a discharging phase in accordance with an embodiment.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a fractional charge pump in a power management integrated circuit. The invention may also be applied, however, to a variety of integrated circuits.

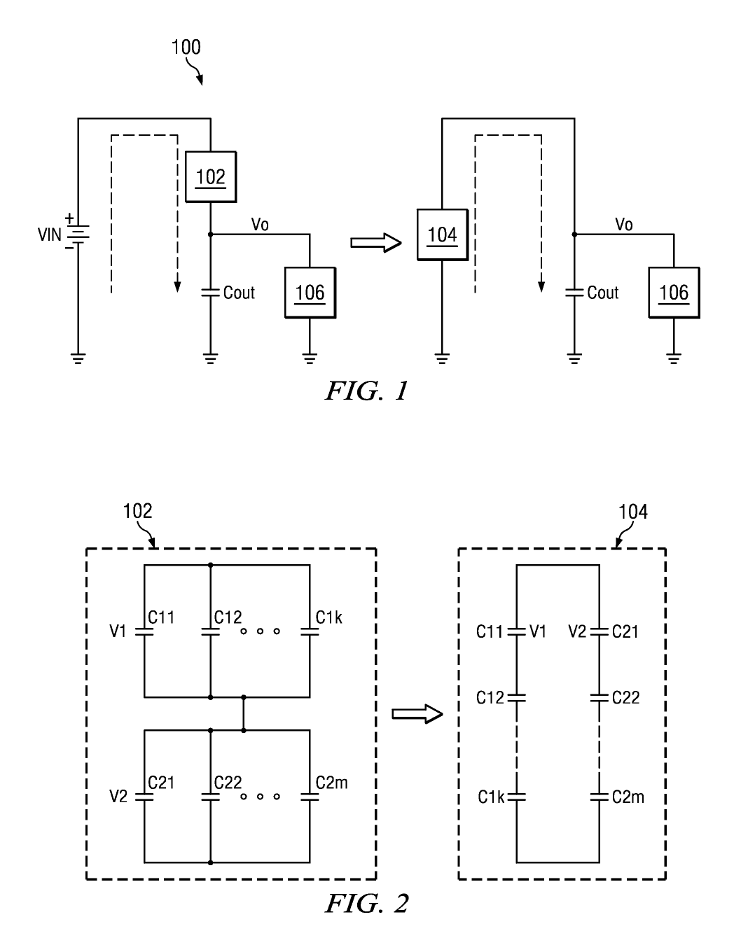

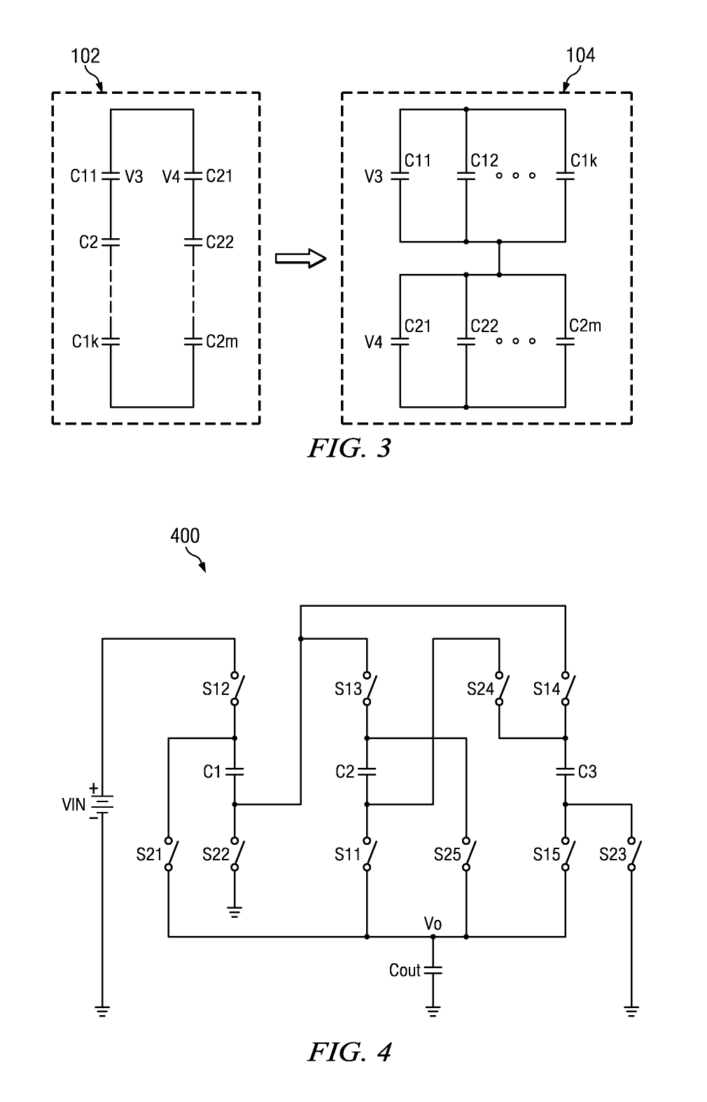

Referring initially to FIG. 1, a block diagram of a fractional charge pump is illustrated in accordance with an embodiment. The fractional charge pump 100 may comprise a plurality of flying capacitors (not shown but illustrated in FIGS. 2 and 3) and switching circuitry (not shown but illustrated in FIG. 4). The switching circuitry may operate in a high switching frequency such as 10 MHz. Each switching cycle can be further divided into a charging phase and a discharging phase.

During a charging phase, the switches of the fractional charge pump are configured such that the flying capacitors are divided into two groups. In particular, the first group may comprise a plurality of capacitors (e.g., k capacitors) connected in parallel or series. The second group may comprise a plurality of capacitors (e.g., m capacitors) connected in parallel or series. Furthermore, the first group and the second group form a charging capacitor configuration 102. Likewise, during a discharging phase, the switches are reconfigured to form a discharging capacitor configuration 104.

As shown in FIG. 1, the charging capacitor configuration 102 is coupled between a positive terminal of an input dc source VIN and an output capacitor Cout, which is connected in parallel with a load 106. During a charging phase, the capacitors (not shown) in the charging capacitor configuration 102 as well as the output capacitor Cout is charged from the input dc source VIN. The dashed line indicates the power flow from the input dc source VIN to the load 106 through the charging capacitor configuration 102.

During a discharging phase, by reconfiguring the switches of the charge pump 100, the discharging capacitor configuration 104 is formed. As shown in FIG. 1, the discharging capacitor configuration 104 is coupled between the output capacitor Cout and ground. The energy stored in the flying capacitors of the charge pump 100 is transferred to the load 106 through the discharging capacitor configuration 104. It should be noted that the pulsing nature of the voltage across the load 106 is typically smoothed by the output capacitor Cout. The detailed schematic diagrams of the charging capacitor configuration 102 and the discharging capacitor configuration 104 are described below with respect to FIGS. 2-9.

FIG. 2 illustrates schematic diagrams of the charging capacitor configuration and the discharging capacitor configuration in accordance an embodiment. A charging capacitor configuration 102 may comprise two capacitor groups connected in series. As shown in FIG. 2, the first charging capacitor group may comprise k capacitors connected in parallel. The second charging capacitor group may comprise m capacitors connected in parallel. During a charging phase, the charging capacitor configuration 102 is coupled between the input dc voltage source VIN and the output Vo (shown in FIG. 1). As a result, the voltage across the charging capacitor configuration 102 is equal to the difference between the input dc voltage source VIN the output voltage Vo.

During a discharging phase, the switches of the fractional charge pump 100 (not shown) are reconfigured to form the discharging capacitor configuration 104. As shown in FIG. 2, the discharging capacitor configuration 104 may comprise two groups of capacitors connected in parallel. The first discharging capacitor group may comprise k capacitors connected in series. The second discharging capacitor group may comprise m capacitors connected in series. The discharging capacitor configuration 104 is coupled between the output Vo and ground. The energy stored in the flying capacitors is transferred to the output Vo during the discharging phase.

In order to better illustrate the operation principle of the fractional charge pump, an ideal charge pump is used to derive the relationship between the output voltage Vo and the input voltage VIN. In addition, assume that each flying capacitor shown in FIG. 2 has the same capacitance. As such, during the discharging phase, in the first discharging capacitor group, the voltage across each capacitor is equal to:

$$V 1 = \frac{{V}_{o}}{k} \qquad ( 1 )$$

where k is the total number of capacitors in the first discharging group. In the second discharging group, the voltage across capacitor is equal to:

$$V 2 = \frac{{V}_{o}}{m} \qquad ( 2 )$$

where m is the total number of capacitors in the second discharging capacitor group.

During the charging phase, the capacitors in the first discharging capacitor group are reconfigured to form the first charging capacitor group Likewise, the capacitors in the second discharging group are reconfigured to form the second charging group. As shown in FIG. 2, the first charging capacitor group and the second charging capacitor group are connected in series. As a result, the voltage difference between the input voltage VIN and the output voltage Vo can be represented by the following:

$$V I N - Vo = V 1 + V 2 = \frac{{V}_{o}}{k} + \frac{{V}_{o}}{m} \qquad ( 3 )$$

which can be reduced to the following:

$${V}_{o} = \frac{m \times k}{m \times k + m + k} V I N \qquad ( 4 )$$

Equation 4 illustrates a general relationship between the input voltage VIN and the output voltage Vo. By selecting different m and k, there may be a variety of fractional charge pumps having a non-integer factor. For example, when m is equal to 1 and k is equal to 2, a ⅖ charge pump can be obtained. The detailed schematic diagram of a ⅖ charge pump will be described below with respect to FIGS. 4-6.

FIG. 3 illustrates schematic diagrams of the charging capacitor configuration and the discharging capacitor configuration in accordance another embodiment. A charging capacitor configuration 102 may comprise two capacitor groups connected in parallel. As shown in FIG. 3, the first charging capacitor group may comprise k capacitors connected in series. The second charging capacitor group may comprise m capacitors connected in series. During a charging phase, the charging capacitor configuration 102 is coupled between the input dc voltage source VIN and the output Vo (shown in FIG. 1). As a result, the voltage across the charging capacitor configuration 102 is equal to the difference between the input dc voltage source VIN the output voltage Vo.

During a discharging phase, the switches of the fractional charge pump are reconfigured to form the discharging capacitor configuration 104. As shown in FIG. 3, the discharging capacitor configuration 104 may comprise two groups of capacitors connected in series. The first discharging capacitor group may comprise k capacitors connected in parallel. The second charging capacitor group may comprise m capacitors connected in parallel. The discharging capacitor configuration 104 is coupled between the output Vo and ground. The energy stored in the flying capacitors is transferred to the output Vo during the discharging phase.

In order to better illustrate the operation principle of the fractional charge pump, an ideal charge pump is used to derive the relationship between the output voltage Vo and the input voltage VIN. In addition, assuming that each flying capacitor shown in FIG. 3 has the same capacitance. As such, during the charging phase, in the first group, the voltage across each capacitor is equal to:

$$V 3 = \frac{V I N - {V}_{o}}{k} \qquad ( 5 )$$

where k is the total number of capacitors in the first group. In the second group, the voltage across capacitor is equal to:

$$V 4 = \frac{V I N - {V}_{o}}{m} \qquad ( 6 )$$

where m is the total number of capacitors in the second group.

During the discharging phase, the capacitors in the first charging capacitor group are reconfigured to form the first discharging capacitor group. Likewise, the capacitors in the second charging group are reconfigured to form the second discharging group. As shown in FIG. 3, the first discharging capacitor group and the second discharging capacitor group are connected in series. As a result, the output voltage Vo can be represented by the following:

$$Vo = V 3 + V 4 = \frac{V I N - {V}_{o}}{k} + \frac{V I N - {V}_{o}}{m} \qquad ( 7 )$$

which can be reduced to the following:

$${V}_{o} = \frac{m + k}{m \times k + m + k} V I N \qquad ( 8 )$$

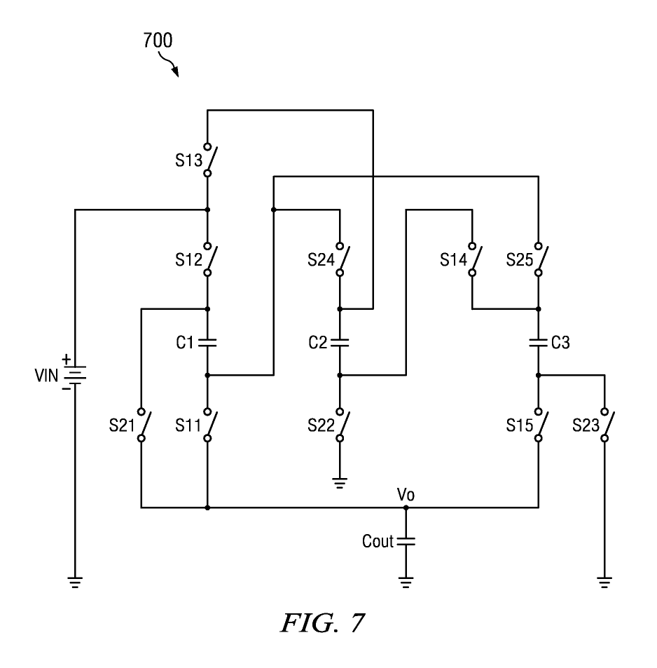

Equation 8 illustrates a general relationship between the input voltage VIN and the output voltage Vo. By selecting different m and k, there may be a variety of fractional charge pumps having a non-integer factor. For example, when m is equal to 1 and k is equal to 2, a ⅗ charge pump can be obtained. The detailed schematic diagram of a ⅗ charge pump will be described below with respect to FIGS. 7-9.

FIG. 4 illustrate in detail a schematic diagram of a ⅖ charge pump in accordance with an embodiment. The ⅖ charge pump 400 shown in FIG. 4 can be obtained from FIG. 2 by selecting k=1 and m=2. The ⅖ charge pump 400 is coupled between an input dc voltage source VIN and an output capacitor Cout. The ⅖ charge pump 400 comprises three flying capacitors, namely C1, C2 and C3. According to the operation principle of the ⅖ charge pump, the flying capacitors can be divided into two groups. The first group includes C1. The second group includes C2 and C3. Substituting k=1 and m=2 into Equation 4 yields that the output voltage Vo is equal to ⅖ times VIN.

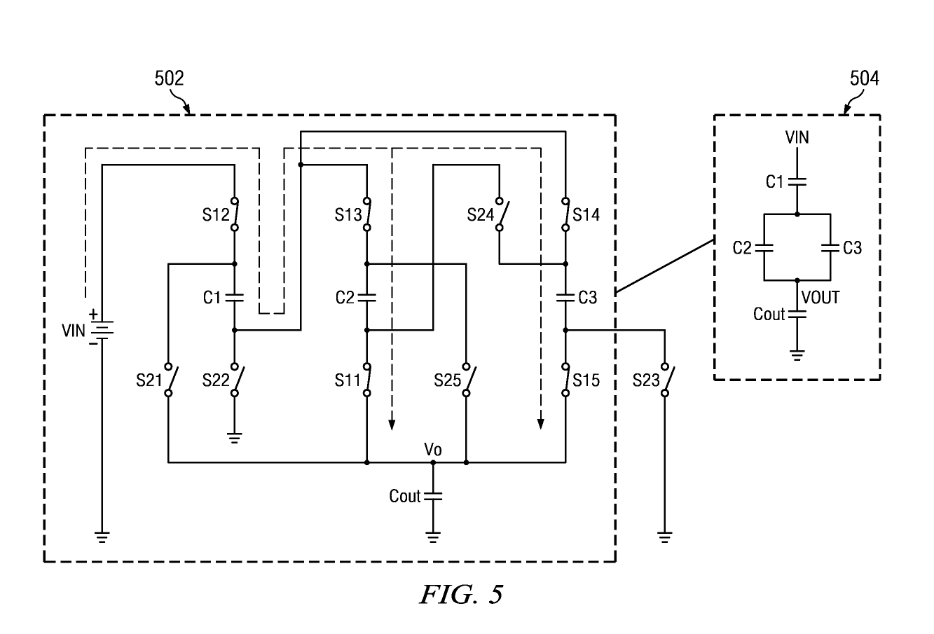

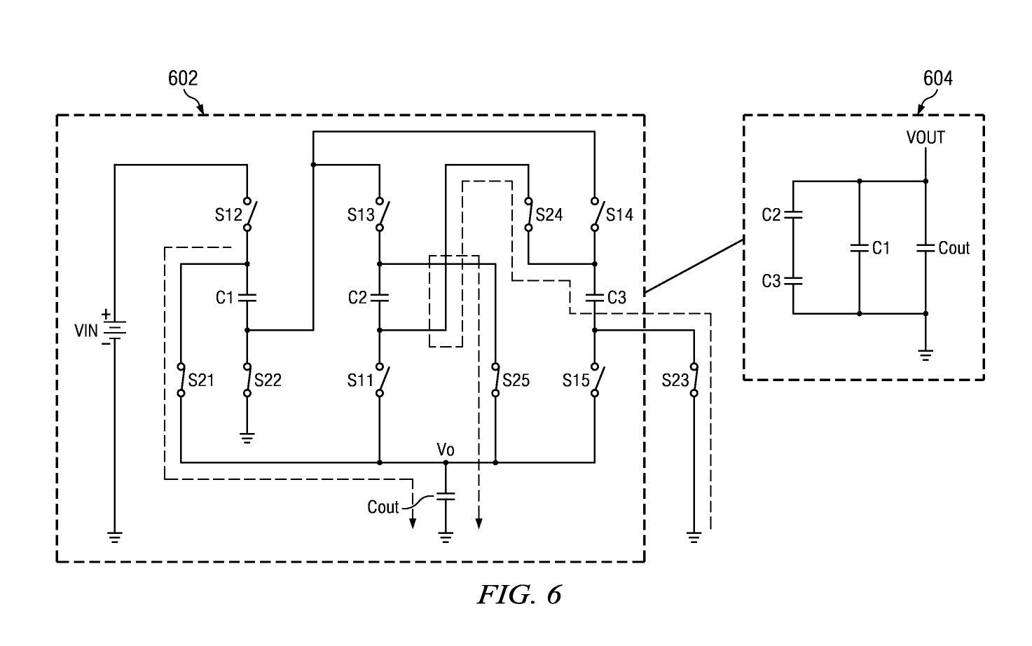

The switching circuitry includes ten switches. These ten switches can be further divided into two groups. The switches of the first group including S11, S12, S13, S14 and S15 are turned on during the charging phase. The switches of the second group including S21, S22, S23, S24 and S25 are turned on during the discharging phase. By reconfiguring the flying capacitors' connection through the switching circuitry, an output voltage equal to ⅖ times VIN can be obtained. The detailed operation of the ⅖ charge pump 400 will be described below with respect to FIGS. 5 and 6. One advantageous feature of the ⅖ charge pump 400 shown in FIG. 4 is that only three flying capacitors and two operational phases are necessary to achieve an output voltage equal to ⅖ times VIN.

FIG. 5 illustrates in detail a schematic diagram of a ⅖ charge pump operating in a charging phase in accordance with an embodiment. As indicated by the dashed lines, the schematic diagram 502 illustrates the power flow during the charging phase of a ⅖ charge pump. As shown in FIG. 5, the first group of switches S11, S12, S13, S14 and S15 are turned on during the charging phase. As a result, flying capacitors C2 and C3 are connected in parallel and further connected in series with the flying capacitor C1. As shown in an equivalent schematic diagram 504, flying capacitors C1, C2 and C3 form a ⅖ charging capacitor configuration. The input dc voltage source VIN charges the output capacitor Cout through the ⅖ charging capacitor configuration.

FIG. 6 illustrates in detail a schematic diagram of a ⅖ charge pump operating in a discharging phase in accordance with an embodiment. As indicated by the dashed lines, the schematic diagram 602 illustrates the power flow during the discharging phase of a ⅖ charge pump. As shown in FIG. 6, the second group of switches S21, S22, S23, S24 and S25 are turned on during the discharging phase. As a result, flying capacitors C2 and C3 are connected in series and further connected in parallel with the flying capacitor C1. As shown in an equivalent schematic diagram 604, flying capacitors C1, C2 and C3 form a ⅖ discharging capacitor configuration. The energy stored in the flying capacitors is transferred to the output through the ⅖ discharging capacitor configuration.

FIG. 7 illustrates in detail a schematic diagram of a ⅗ charge pump in accordance with an embodiment. The ⅗ charge pump 700 shown in FIG. 7 can be obtained from FIG. 3 by selecting k=1 and m=2. The ⅗ charge pump 700 is coupled between an input dc voltage source VIN and an output capacitor Cout. Similar to the ⅖ charge pump 400 shown in FIG. 4, the ⅗ charge pump 700 shown in FIG. 7 comprises three flying capacitors C1, C2 and C3 which can be divided into two groups. The first group includes C1. The second group includes C2 and C3. Substituting k=1 and m=2 into Equation 8 yields that the output voltage Vo is equal to ⅗ times VIN.

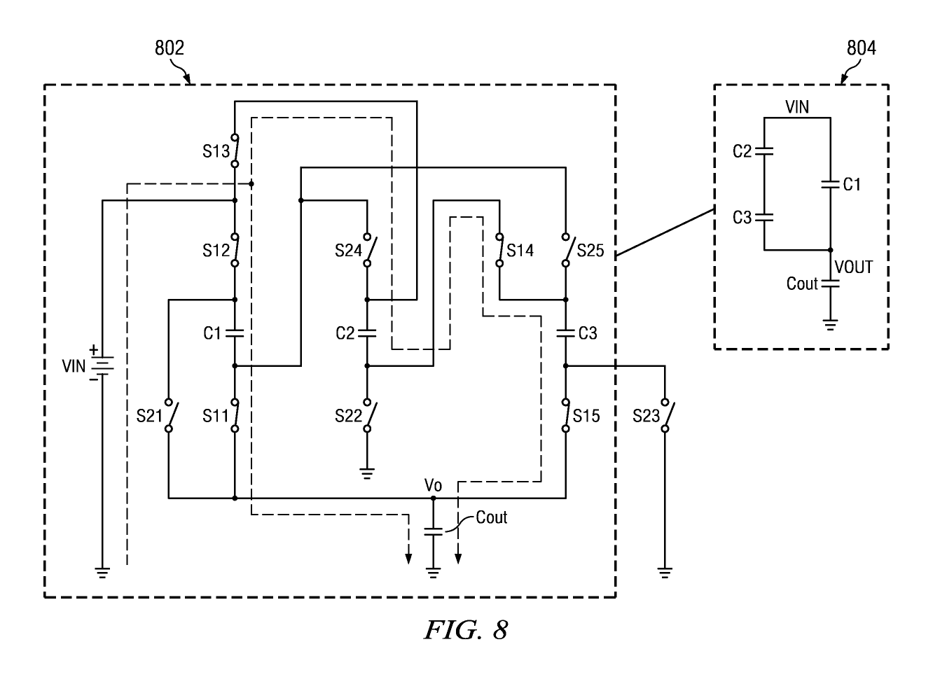

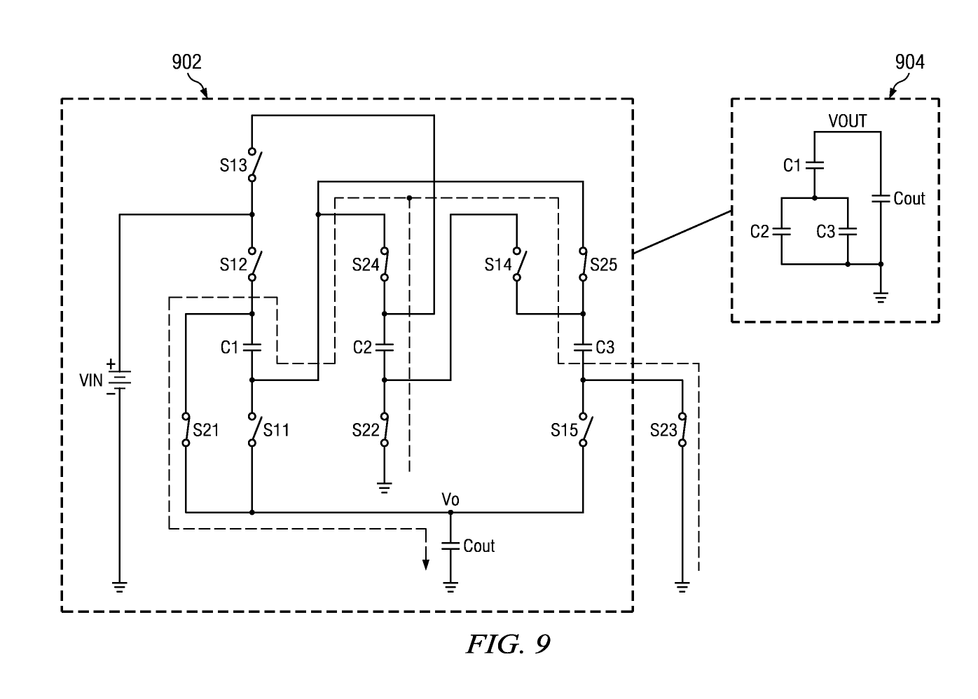

The switching circuitry includes ten switches. These ten switches can be further divided into two groups. The switches of the first group including S11, S12, S13, S14 and S15 are turned on during the charging phase. The switches of the second group including S21, S22, S23, S24 and S25 are turned on during the discharging phase. By reconfiguring the flying capacitors' connection through the switching circuitry, an output voltage equal to ⅗ times VIN can be obtained. The detailed operation of the ⅗ charge pump 700 will be described below with respect to FIGS. 8 and 9.

FIG. 8 illustrates in detail a schematic diagram of a ⅗ charge pump operating in a charging phase in accordance with an embodiment. As indicated by the dashed lines, the schematic diagram 802 illustrates the power flow during the charging phase of a ⅗ charge pump. As shown in FIG. 8, the first group of switches S11, S12, S13, S14 and S15 are turned on during the charging phase. As a result, flying capacitors C2 and C3 are connected in series and further connected in parallel with the flying capacitor C1. As shown in an equivalent schematic diagram 804, flying capacitors C1, C2 and C3 form a ⅗ charging capacitor configuration. The input dc voltage source VIN charges the output capacitor Cout through the ⅗ charging capacitor configuration.

FIG. 9 illustrates in detail a schematic diagram of a ⅗ charge pump operating in a discharging phase in accordance with an embodiment. As indicated by the dashed lines, the schematic diagram 902 illustrates the power flow during the discharging phase of a ⅗ charge pump. As shown in FIG. 9, the second group of switches S21, S22, S23, S24 and S25 are turned on during the discharging phase. As a result, flying capacitors C2 and C3 are connected in parallel and further connected in series with the flying capacitor C1. As shown in an equivalent schematic diagram 904, flying capacitors C1, C2 and C3 form a ⅗ discharging capacitor configuration. The energy stored in the flying capacitors is transferred to the output through the ⅗ discharging capacitor configuration.

Although embodiments of the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An apparatus comprising:
a plurality of flying capacitors; and
a switching circuit coupled to the plurality of flying capacitors, wherein the switching circuit is configured such that:
in a first operational phase, a dc input power source and the plurality of flying capacitors in a first capacitor configuration are stacked together and further coupled to an output capacitor; and
in a second operational phase, the plurality of flying capacitors in a second capacitor configuration are coupled between ground and the output capacitor.

2. The apparatus of claim 1, wherein:
the first capacitor configuration comprises:
a plurality of first capacitors connected in parallel; and
a plurality of second capacitors connected in parallel, wherein the plurality of first capacitors and the plurality of second capacitors are connected in series; and
the second capacitor configuration comprises:
the plurality of first capacitors connected in series; and
the plurality of second capacitors connected in series, wherein the plurality of first capacitors and the plurality of second capacitors are connected in parallel.

3. The apparatus of claim 1, wherein:
the first capacitor configuration comprises:
a plurality of first capacitors connected in series; and
a plurality of second capacitors connected in series, wherein the plurality of first capacitors and the plurality of second capacitors are connected in parallel; and
the second capacitor configuration comprises:
the plurality of first capacitors connected in parallel; and
the plurality of second capacitors connected in parallel, wherein the plurality of first capacitors and the plurality of second capacitors are connected in series.

4. The apparatus of claim 1, wherein:
the first capacitor configuration comprises:
a first capacitor; and
a first capacitor group formed by a second capacitor and a third capacitor connected in parallel, wherein the first capacitor and the first capacitor group are connected in series; and
the second capacitor configuration comprises:
the first capacitor; and
a second capacitor group formed by the second capacitor and the third capacitor connected in series, wherein the first capacitor and the second capacitor group are connected in parallel.

5. The apparatus of claim 4, wherein the first capacitor, the second capacitor, the third capacitor and the switching circuit form a ⅖ charge pump.

6. The apparatus of claim 1, wherein:
the first capacitor configuration comprises:
a first capacitor; and
a first capacitor group formed by a second capacitor and a third capacitor connected in series, wherein the first capacitor and the first capacitor group are connected in parallel; and
the second capacitor configuration comprises:
the first capacitor; and
a second capacitor group formed by the second capacitor and the third capacitor connected in series, wherein the first capacitor and the second capacitor group are connected in parallel.

7. The apparatus of claim 6, wherein the first capacitor, the second capacitor, the third capacitor and the switching circuit form a ⅗ charge pump.

8. A charge pump comprising:
a first capacitor group comprising a first flying capacitor;
a second capacitor group comprising a second flying capacitor and a third flying capacitor, wherein the first capacitor group and the second capacitor group are coupled between a dc input power source and an output capacitor; and
a switching circuit coupled to the first capacitor group and the second capacitor group, wherein the switching circuit is configured such that:
in a first operational phase, the dc input power source charges the output capacitor through the first capacitor group and the second capacitor group; and
in a second operational phase, the first capacitor group and the second capacitor group charges the output capacitor.

9. The charge pump of claim 8, wherein:
in the first operational phase, the second capacitor group comprises the second flying capacitor and the third flying capacitor connected in parallel, and the first flying capacitor and the second capacitor group are connected in series; and
in the second operational phase, the second capacitor group comprises the second flying capacitor and the third flying capacitor connected in series, and the first flying capacitor and the second capacitor group are connected in parallel.

10. The charge pump of claim 9, wherein the first flying capacitor, the second flying capacitor and the third flying capacitor and the switching circuit form a ⅖ charge pump.

11. The charge pump of claim 8, wherein:
in the first operational phase, the second capacitor group comprises the second flying capacitor and the third flying capacitor connected in series, and the first flying capacitor and the second capacitor group are connected in parallel; and
in the second operational phase, the second capacitor group comprises the second flying capacitor and the third flying capacitor connected in parallel, and the first flying capacitor and the second capacitor group are connected in series.

12. The charge pump of claim 11, wherein the first flying capacitor, the second flying capacitor and the third flying capacitor and the switching circuit form a ⅗ charge pump.

13. The charge pump of claim 8, wherein the first flying capacitor comprises a plurality of capacitors connected in parallel.

14. The charge pump of claim 8, wherein the first flying capacitor comprises a plurality of capacitors connected in series.

15. A method comprising:
configuring a switching circuit to form a first capacitor configuration;
a dc power source charging an output capacitor through the first capacitor configuration;
reconfiguring the switching circuit to form a second capacitor configuration; and
transferring energy stored in the second capacitor configuration to the output capacitor.

16. The method of claim 15, further comprising:
forming the first capacitor configuration comprising:
a plurality of first capacitors connected in parallel; and
a plurality of second capacitors connected in parallel, wherein the plurality of first capacitors and the plurality of second capacitors are connected in series; and
forming the second capacitor configuration comprising:
the plurality of first capacitors connected in series; and
the plurality of second capacitors connected in series, wherein the plurality of first capacitors and the plurality of second capacitors are connected in parallel.

17. The method of claim 15, further comprising:
forming the first capacitor configuration comprising:
a plurality of first capacitors connected in series; and
a plurality of second capacitors connected in series, wherein the plurality of first capacitors and the plurality of second capacitors are connected in parallel; and
forming the second capacitor configuration comprising:
the plurality of first capacitors connected in parallel; and
the plurality of second capacitors connected in parallel, wherein the plurality of first capacitors and the plurality of second capacitors are connected in series.

18. The method of claim 15, further comprising:
forming the first capacitor configuration comprising:
a first capacitor group comprising a first flying capacitor; and
a second capacitor group comprising a second flying capacitor and a third flying capacitor connected in parallel, wherein the first capacitor group and the second capacitor group are connected in series; and
forming the second capacitor configuration comprising:
a third capacitor group comprising the first flying capacitor; and
a fourth capacitor group comprising the second flying capacitor and the third flying capacitor connected in series, wherein the third capacitor group and the fourth capacitor group are connected in parallel.

19. The method of claim 18, further comprising:
forming a ⅖ charge pump using the first flying, the second flying capacitor, the third flying capacitor and the switching circuit.

20. The method of claim 15, further comprising:
forming the first capacitor configuration comprising:
a first capacitor group comprising a first flying capacitor; and
a second capacitor group comprising a second flying capacitor and a third flying capacitor connected in series, wherein the first capacitor group and the second capacitor group are connected in parallel; and
forming the second capacitor configuration comprising:
a third capacitor group comprising the first flying capacitor; and
a fourth capacitor group comprising the second flying capacitor and the third flying capacitor connected in parallel, wherein the third capacitor group and the fourth capacitor group are connected in series.

21. The method of claim 20, further comprising:
forming a ⅗ charge pump using the first flying, the second flying capacitor, the third flying capacitor and the switching circuit.
